(19) United States
(12) Patent Application Publication
(10) Pub. No.: US 2022/0207408 A1
(43) Pub. Date: Jun. 30, 2022

(54) MAPPING MACHINE LEARNING ACTIVATION DATA TO A REPRESENTATIVE VALUE PALETTE

(71) Applicant: ATI TECHNOLOGIES ULC, MARKHAM (CA)

(72) Inventors: IHAB AMER, MARKHAM (CA); MEHDI SAEEDI, MARKHAM (CA); GABOR SINES, MARKHAM (CA)

(21) Appl. No.: 17/134,804

(22) Filed: Dec. 28, 2020

(51) Int. Cl. G06N 20/00; G06K 9/62

(52) U.S. Cl. CPC G06N 20/00; G06K 9/6228; G06K 9/6232

(57) ABSTRACT

Mapping machine learning activation data to a representative value palette, including: selecting, from a plurality of activation values of a model execution, a plurality of representative values; identifying, for each activation value of the plurality of activation values, a representative value of the plurality of representative values; calculating, for each activation value of the plurality of activation values, a corresponding residual value as a difference between an activation value and a corresponding representative value; and storing, for each activation value of the plurality of activation values, the corresponding residual value and an index of the corresponding representative value.

### BACKGROUND

Machine learning operations such as deep learning or neural networks use multiple stages or layers. Each layer provides its output, referred to as “activation data,” as input to a next layer until a final layer provides the output of the model. Storing the activation data in cache is prohibitively expensive. Accordingly, the activation data is written to and read from non-cache memory. Accordingly, it is beneficial to reduce the overall size of activation data written to or read from memory in order to improve memory bandwidth and increase performance.

### BRIEF DESCRIPTION OF THE DRAWINGS

FIG. 1 is a block diagram of an example computer for mapping machine learning activation data to a representative value palette according to some embodiments.

FIG. 2 is a diagram of example data for mapping machine learning activation data to a representative value palette according to some embodiments.

FIG. 3 is a flowchart of an example method for mapping machine learning activation data to a representative value palette according to some embodiments.

FIG. 4 is a flowchart of an example method for mapping machine learning activation data to a representative value palette according to some embodiments.

FIG. 5 is a flowchart of an example method for mapping machine learning activation data to a representative value palette according to some embodiments.

FIG. 6 is a flowchart of an example method for mapping machine learning activation data to a representative value palette according to some embodiments.

FIG. 7 is a flowchart of an example method for mapping machine learning activation data to a representative value palette according to some embodiments.

### DETAILED DESCRIPTION

In some embodiments, a method of mapping machine learning activation data to a representative value palette includes selecting, from a plurality of activation values of a model execution, a plurality of representative values; identifying, for each activation value of the plurality of activation values, a representative value of the plurality of representative values; calculating, for each activation value of the plurality of activation values, a corresponding residual value as a difference between an activation value and a corresponding representative value; and storing, for each activation value of the plurality of activation values, the corresponding residual value and an index of the corresponding representative value.

In some embodiments, the method further includes applying a quantization function to the corresponding residual value for each activation value of the plurality of activation values. In some embodiments, the method further includes compressing, for each activation value of the plurality of activation values, one or more of the corresponding residual value and the index of the corresponding representative value. In some embodiments, the plurality of representative values include a selection of most frequently occurring activation values. In some embodiments, the method further includes: identifying a particular index value and a particular residual value corresponding to a particular activation value of the plurality of activation values; identifying a particular representative value corresponding to the particular index value; and generating a reconstructed activation value based on the particular representative value and the particular residual value. In some embodiments, the method further includes decompressing one or more of a plurality of index values or a plurality of residual values. In some embodiments, d the index of the corresponding representative value is stored at a lesser degree of precision relative to the plurality of activation values.

In some embodiments, an apparatus for mapping machine learning activation data to a representative value palette performs steps including: selecting, from a plurality of activation values of a model execution, a plurality of representative values; identifying, for each activation value of the plurality of activation values, a representative value of the plurality of representative values; calculating, for each activation value of the plurality of activation values, a corresponding residual value as a difference between an activation value and a corresponding representative value; and storing, for each activation value of the plurality of activation values, the corresponding residual value and an index of the corresponding representative value.

In some embodiments, the steps further include applying a quantization function to the corresponding residual value for each activation value of the plurality of activation values. In some embodiments, the steps further include compressing, for each activation value of the plurality of activation values, one or more of the corresponding residual value and the index of the corresponding representative value. In some embodiments, the plurality of representative values include a selection of most frequently occurring activation values. In some embodiments, the steps further include: identifying a particular index value and a particular residual value corresponding to a particular activation value of the plurality of activation values; identifying a particular representative value corresponding to the particular index value; and generating a reconstructed activation value based on the particular representative value and the particular residual value. In some embodiments, the steps further include decompressing one or more of a plurality of index values or a plurality of residual values. In some embodiments, the index of the corresponding representative value is stored at a lesser degree of precision relative to the plurality of activation values.

In some embodiments, a computer program product disposed upon a non-transitory computer readable medium stores computer program instructions for mapping machine learning activation data to a representative value palette that, when executed, cause a computer system to perform steps including: selecting, from a plurality of activation values of a model execution, a plurality of representative values; identifying, for each activation value of the plurality of activation values, a representative value of the plurality of representative values; calculating, for each activation value of the plurality of activation values, a corresponding residual value as a difference between an activation value and a corresponding representative value; and storing, for each activation value of the plurality of activation values, the corresponding residual value and an index of the corresponding representative value.

In some embodiments, the steps further include applying a quantization function to the corresponding residual value for each activation value of the plurality of activation values. In some embodiments, the steps further include compressing, for each activation value of the plurality of activation values, one or more of the corresponding residual value and the index of the corresponding representative value. In some embodiments, the plurality of representative values include a selection of most frequently occurring activation values. In some embodiments, the steps further include: identifying a particular index value and a particular residual value corresponding to a particular activation value of the plurality of activation values; identifying a particular representative value corresponding to the particular index value; and generating a reconstructed activation value based on the particular representative value and the particular residual value. In some embodiments, the steps further include decompressing one or more of a plurality of index values or a plurality of residual values. In some embodiments, the corresponding residual value and the index of the corresponding representative value are stored at an equal degree of precision relative to the plurality of activation values.

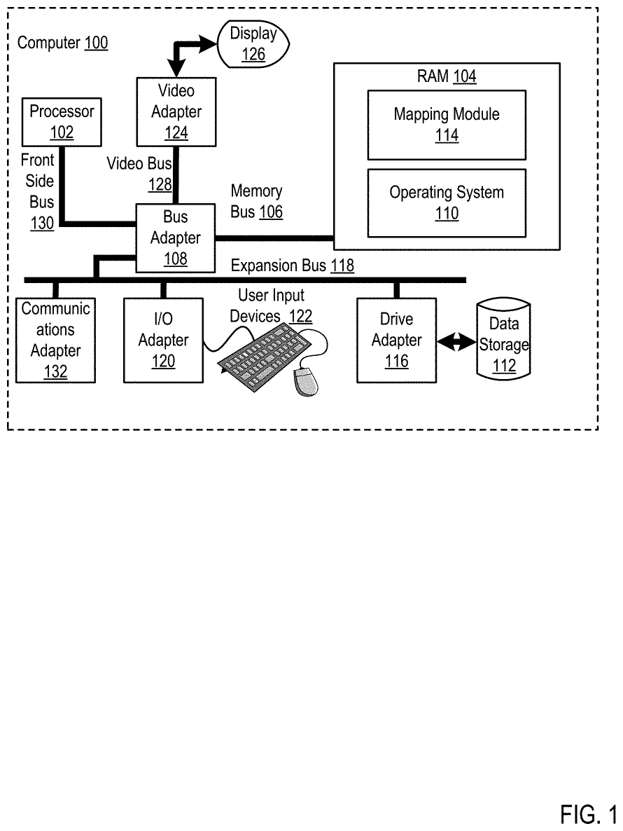

Mapping machine learning activation data to a representative value palette in accordance with the present application is generally implemented with computers, that is, with automated computing machinery. For further explanation, therefore, FIG. 1 sets forth a block diagram of computing machinery including an exemplary computer 100 configured for mapping machine learning activation data to a representative value palette according to certain embodiments. The example computer 100 can be implemented in a variety of computing devices, including mobile devices, personal computers, peripheral hardware components, gaming devices, set-top boxes, and the like. The computer 100 of FIG. 1 includes at least one computer processor 102 or ‘CPU’ as well as random access memory 104 (RAM′) which is connected through a high speed memory bus 106 and bus adapter 108 to processor 102 and to other components of the computer 100.

Stored in RAM 104 is an operating system 110. Operating systems useful in computers configured for mapping machine learning activation data to a representative value palette according to certain embodiments include UNIX™, Linux™, Microsoft Windows™, and others as will occur to those of skill in the art. The operating system 110 in the example of FIG. 1 is shown in RAM 104, but many components of such software typically are stored in non-volatile memory also, such as, for example, on data storage 112, such as a disk drive. Also stored in RAM is the mapping module 114 a module for mapping machine learning activation data to a representative value palette according to certain embodiments.

The computer 100 of FIG. 1 includes disk drive adapter 116 coupled through expansion bus 118 and bus adapter 108 to processor 102 and other components of the computer 100. Disk drive adapter 116 connects non-volatile data storage to the computer 100 in the form of data storage 112. Disk drive adapters useful in computers configured for mapping machine learning activation data to a representative value palette according to certain embodiments include Integrated Drive Electronics (‘IDE’) adapters, Small Computer System Interface (SCSI′) adapters, and others as will occur to those of skill in the art. In some embodiments, non-volatile computer memory is implemented as an optical disk drive, electrically erasable programmable read-only memory (so-called ‘EEPROM’ or ‘Flash’ memory), RAM drives, and so on, as will occur to those of skill in the art.

The example computer 100 of FIG. 1 includes one or more input/output (I/O′) adapters 120. I/O adapters implement user-oriented input/output through, for example, software drivers and computer hardware for controlling output to display devices such as computer display screens, as well as user input from user input devices 122 such as keyboards and mice. The example computer 100 of FIG. 1 includes a video adapter 124, which is an example of an I/O adapter specially designed for graphic output to a display device 126 such as a display screen or computer monitor. Video adapter 124 is connected to processor 102 through a high speed video bus 128, bus adapter 108, and the front side bus 130, which is also a high speed bus.

The exemplary computer 100 of FIG. 1 includes a communications adapter 132 for data communications with other computers and for data communications with a data communications network. Such data communications are carried out serially through RS-232 connections, through external buses such as a Universal Serial Bus (‘USB’), through data communications networks such as IP data communications networks, and/or in other ways as will occur to those of skill in the art. Communications adapters implement the hardware level of data communications through which one computer sends data communications to another computer, directly or through a data communications network. Examples of communications adapters useful in computers configured for mapping machine learning activation data to a representative value palette according to certain embodiments include modems for wired dial-up communications, Ethernet (IEEE 802.3) adapters for wired data communications, and 802.11 adapters for wireless data communications.

Machine learning operations such as deep learning or neural networks use multiple stages or layers. For example, a first layer of a model accepts input data and provides output data to a next layer in the model. Each layer provides its output as input to a next layer until a final layer provides the output of the model. The data output by each layer that is provided as input to a next layer is hereinafter referred to as “activation data.” The activation data includes one or more values (e.g., activation values) generated by a given layer of a model and provided as input to another layer of the model. In some embodiments, the activation data is encoded as a one-dimensional data structure, such as a list or array of activation values. In other embodiments, the activation data is encoded as a multidimensional data structure, such as an array of activation values.

As activation data is generated, storing the activation data in cache is prohibitively expensive. Accordingly, the activation data is written to and read from non-cache memory (e.g., ram 104 or data storage 112). For example, in some embodiments, the activation data is written to memory at each layer, and then read from memory to provide the activation data as input to the next layer. In other embodiments, the activation data is written to memory after multiple layers. One skilled in the art will appreciate that the frequency at which activation data is written to memory is dependent on the particular machine learning application or model executed, as well as the particular hardware configurations of the computer 100 executing the model.

The periodic writing or reading of activation data causes memory traffic, thereby affecting overall performance of a system. Accordingly, it is beneficial to reduce the overall size of activation data written to or read from memory in order to improve memory bandwidth and increase performance. Existing solutions to reduce the memory bandwidth requirements of activation data include applying compression algorithms, quantization algorithms, or combinations thereof. For example, a compression algorithm reduces the overall size of data required to write a given block of activation data to memory. A quantization algorithm that reduces the precision of the encoded activation data while keeping accuracy at an acceptable level will also reduce the memory requirements for activation data by virtue of the reduced precision. For example, assuming an unquantized activation value that requires 32 bits of precision, a quantized activation value that uses 16 bits of precision will reduce the overall memory requirements for the activation data.

To further increase the memory bandwidth efficiency for storing and reading activation data, the mapping module 114 for mapping machine learning activation data to a representative value palette reduces the entropy of activation data by mapping each activation value to a “palette” of representative values selected from the activation data. By storing each activation value of the activation data as being mapped to a subset of the activation values (e.g., the representative values), the overall entropy of the activation data is reduced. When applying a compression algorithm to data with reduced entropy, the overall efficiency of the compression algorithm is increased, leading to reduced data transfer when reading or writing data.

For example, assume that, during execution of a machine learning model, a block of activation data including a plurality of activation values is generated. In some embodiments, the block of activation data is of a fixed size. In other embodiments, the block of activation data is adaptively determined. For example, in some embodiments, the block of activation data includes the activation data generated for the entirety of a given layer. In other embodiments, the block of activation data includes a subdivision of the activation data for a given layer. For example, where the machine learning model is an image classifier accepting an image as input, a block of activation data includes the activation data for a given channel of the image generated by the given layer. Thus, a given layer generates a block of activation data for each channel of the input image.

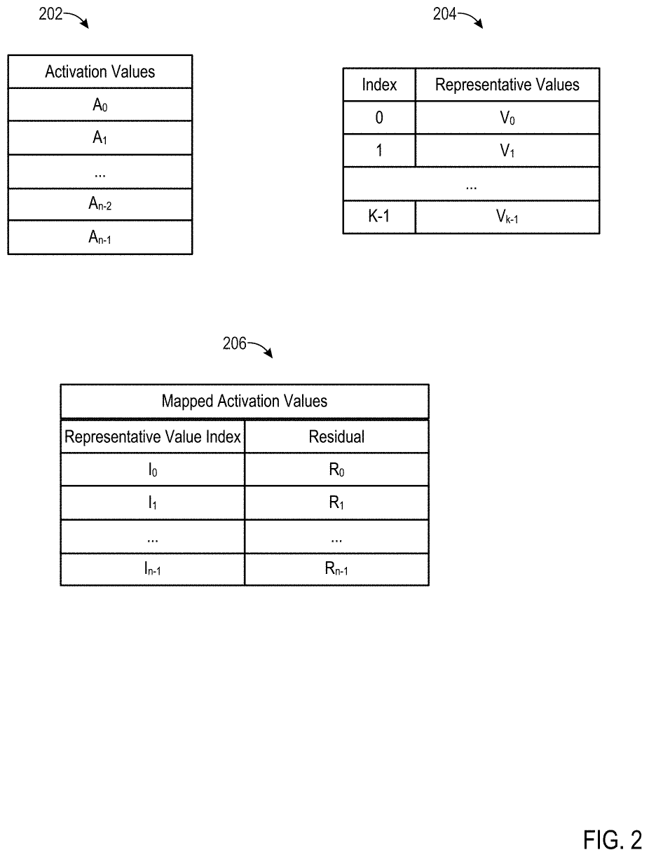

The mapping module 114 then selects a plurality of representative values from the plurality of activation values in the block of activation data. The selected plurality of representative values form the “palette” to which each of the activation values in the block will be mapped, as described below. In some embodiments, the selected plurality of representative values include a predefined number of the activation values most represented in the plurality of activation values. For example, consider an example activation value table 202 as shown in FIG. 2. The activation value table 202 shows N activation values A₀-Aₙ₋₁. From the activation value table 202, the K-most frequently occurring activation values are selected as shown in the representative value table 204. The representative value table 204 shows the K representative values as representative values V₀-Vₖ₋₁, indexed from index 0 to index K−1. Although the representative values are described as being selected as the most frequently occurring activation values in the plurality of activation values, it is understood that other criteria are used for selecting the representative values according to some embodiments. For example, activation values meeting a threshold are selected, or activation values falling below a threshold are removed.

The mapping module 114 then identifies, for each activation value of the plurality of activation values, a nearest representative value of the plurality of representative values. For a given activation value, the nearest representative value is the one of the representative values having a lowest difference when compared to the given activation value. Thus, for each activation value of the plurality of activation values, a corresponding nearest representative value is determined. It is understood that, in other embodiments, criteria other than nearness is used in order to identify for each activation value, a corresponding representative value.

The mapping module 114 then calculates, for each activation value of the plurality of activation values, a corresponding residual value. A residual value for a given activation value is the difference between the given activation value and its nearest representative value. For example, assuming an activation value Aᵢ with a nearest representative value Vⱼ, the residual value Rᵢ is calculated as R=Vᵢ−Aᵢ. Thus, each activation value of the plurality of activation values is representable by a combination of a representative value and a residual value.

Instead of storing the activation values in memory for later retrieval, the mapping module 114 stores, for each activation value of the plurality of activation values, the corresponding residual value and an index of the corresponding nearest representative value. For example, the mapping module 114 generates (e.g., in cache), a first block of data including the indexes of each nearest representative value (e.g., assuming N activation values, the first block includes N index values). The mapping module 114 then also generates (e.g., in cache), a second block of data including the corresponding residual values for the activation values (e.g., assuming N activation values, the first block includes N residual values). In some embodiments, the mapping module 114 generates separate blocks for the index values and the residual values. In other embodiments, the mapping module 114 generates a single block storing entries combining the index values and residual values corresponding to each activation value.

Returning to the example tables of FIG. 2, the example mapped activation value table 206 depicts how activation values are encoded for storage. For each of activation values A₀-Aₙ₋₁, a corresponding index value I₀-Iₙ₋₁ is stored referencing the corresponding nearest representative value. Also, for each of activation values A₀-Aₙ₋₁, a residual value R₀-Rₙ₋₁ is stored.

The index values identify a particular index of the representative values, which have a lesser number of entries compared to the activation values. Accordingly, in some embodiments, the index values are encoded with fewer bits (e.g., with lesser precision) than the activation values. For example, assume that activation values are encoded using 32 bits and that 128 representative values are selected from the plurality of activation values. In this example, an index value is encoded using 1 byte (8 bits) compared to the 32 bits required to encode an activation value.

In some embodiments, to store the corresponding residual value and an index of the corresponding nearest representative value for each activation value of the plurality of activation values, the mapping module 114 compresses the residual values and the index values prior to storage. For example, a statistical compression algorithm, a differential compression algorithm, or another compression algorithm is applied to the index values and residual values. As the index values have a reduced entropy when compared to the original activation values, a greater compression efficiency is achieved relative to compressing and storing the activation values.

In some embodiments, the mapping module 114 applies a quantization function to the residual values prior to storage. For example, the mapping module 114 applies a quantization function to the residual values prior to compression. The quantization function serves to constrain or map the residual values to a smaller or discrete set of values. For example, in some embodiments, the quantization function rounds an input residual value up or down. In other embodiments, the quantization function reduces a degree of precision of the input residual value (e.g., by reducing a number of bits used to encode the residual value). As quantizing the residual values serves to reduce the entropy of the residual values, a greater compression efficiency is achieved when compared to compressing the unquantized residual values. Moreover, a quantization function that reduces a degree of precision for encoding the residual values also reduces the amount of memory required to store the residual values. Notably, while the compression applied to the index values and residual values is lossless, the application of a quantization function is lossy. Accordingly, one skilled in the art would appreciate that the particular quantization function applied to the residual values is chosen in order to maintain a necessary level of accuracy for the particular machine learning application while suffering an acceptable degree of loss.

In order to reconstruct a particular activation value for use in a machine learning application (e.g., to be provided as input to a next layer in a model), the mapping module 114 identifies a particular index value and a particular residual value for the particular activation value to be reconstructed. For example, to reconstruct activation value Aⱼ, the mapping module 114 loads from memory the index value Iⱼ and the residual value Rⱼ. The mapping module 114 then loads, as the nearest representative value corresponding to the particular activation value, a representative value at index Iⱼ. The mapping module 114 then generates a reconstructed activation value by adding the loaded residual value and the nearest representative value referenced by the loaded index Iⱼ. In some embodiments, the loaded residual value was quantized prior to storage. Accordingly, in such embodiments, the reconstructed activation value does not always equal the original activation value due to lossy quantization of the residual value. In some embodiments, the identified representative values are maintained in the cache while the index values and residual values are stored to and loaded from memory.

As the stored index values and residual values are compressed in some embodiments, reconstructing a particular activation value includes decompressing the stored index value and residual value. For example, the mapping module 114 loads a data block of index values and a data block of residual values from memory. The memory module 114 then decompresses the loaded data blocks to generate uncompressed data blocks of index values and residual values. The index value and residual value for the particular activation value to be reconstructed are then loaded from the uncompressed data blocks of index values and residual values.

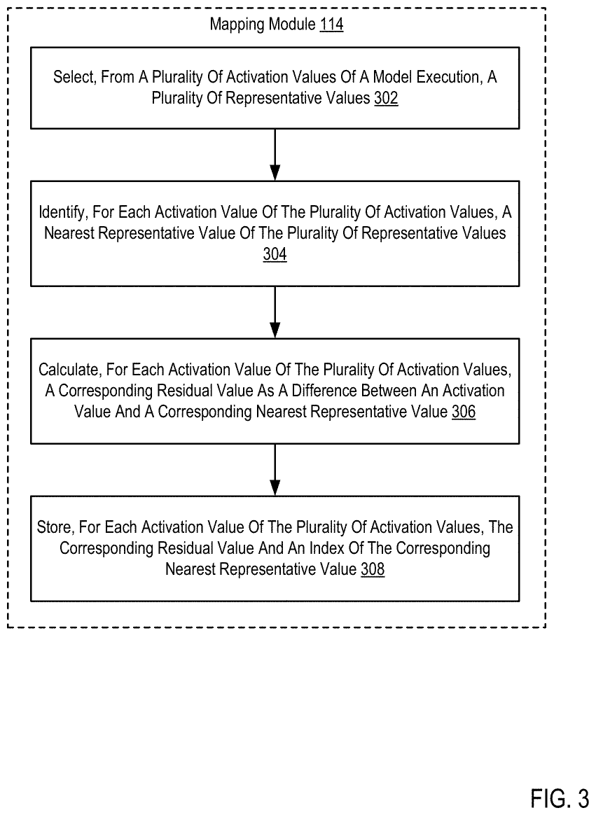

For further explanation, FIG. 3 sets forth a flow chart illustrating an exemplary method for mapping machine learning activation data to a representative value palette that includes selecting 302 (e.g., by a mapping module 114), from a plurality of activation values of a model execution, a plurality of representative values. For example, assume that, during execution of a machine learning model, a block of activation data including a plurality of activation values is generated. In some embodiments, the plurality of activation values correspond to a list or other one-dimensional data structure of values. In other embodiments, the plurality of activation values correspond to a matrix of values, or another multidimensional data structure. In some embodiments, the block of activation data is of a fixed size. In other embodiments, the block of activation data is adaptively determined. For example, in some embodiments, the block of activation data includes the activation data generated for the entirety of a given layer. In other embodiments, the block of activation data includes a subdivision of the activation data for a given layer. For example, where the machine learning model is an image classifier accepting an image as input, a block of activation data includes the activation data for a given channel of the image generated by the given layer. Thus, a given layer generates a block of activation data for each channel of the input image.

Selecting 302 the plurality of representative values includes selecting the plurality of representative values from the block of activation data. The selected plurality of representative values form the “palette” to which each of the activation values in the block will be mapped, as described below. In some embodiments, the selected 302 plurality of representative values include a predefined number of the activation values most represented in the plurality of activation values. In other embodiments, other criteria are used for selecting the representative values. One skilled in the art will appreciate that, in some embodiments, the particular criteria for selecting the representative values is determined based on particular design considerations of the particular machine learning application implementing the model that generates the activation data.

The method of FIG. 3 also includes identifying 304, for each activation value of the plurality of activation values, a nearest representative value of the plurality of representative values. For a given activation value, the nearest representative value is the one of the representative values having a lowest difference when compared to the given activation value. Thus, for each activation value of the plurality of activation values, a corresponding nearest representative value is determined.

The method of FIG. 3 also includes calculating 306, for each activation value of the plurality of activation values, a corresponding residual value as a difference between an activation value and a corresponding nearest representative value. For example, assuming an activation value Aᵢ with a nearest representative value Vⱼ, the residual value Rᵢ is calculated as Rᵢ=Vᵢ−Aᵢ. Thus, each activation value of the plurality of activation values is representable by a combination of a representative value and a residual value.

The method of FIG. 3 also includes storing 308, for each activation value of the plurality of activation values, the corresponding residual value and an index of the corresponding nearest representative value. For example, the mapping module 114 generates (e.g., in cache), a first block of data including the indexes of each nearest representative value (e.g., assuming N activation values, the first block includes N index values). The mapping module 114 then also generates (e.g., in cache), a second block of data including the corresponding residual values for the activation values (e.g., assuming N activation values, the first block includes N residual values). In some embodiments, the mapping module 114 generates separate blocks for the index values and the residual values. In other embodiments, the mapping module 114 generates a single block storing entries combining the index values and residual values corresponding to each activation value.

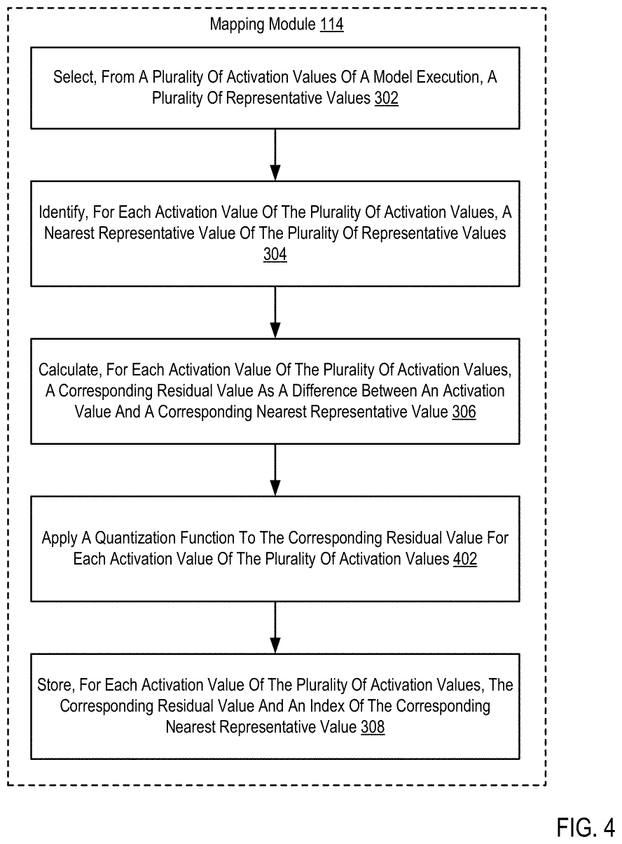

For further explanation, FIG. 4 sets forth a flow chart illustrating an exemplary method for mapping machine learning activation data to a representative value palette that includes selecting 302 (e.g., by a mapping module 114), from a plurality of activation values of a model execution, a plurality of representative values; identifying 304, for each activation value of the plurality of activation values, a nearest representative value of the plurality of representative values; calculating 306, for each activation value of the plurality of activation values, a corresponding residual value as a difference between an activation value and a corresponding nearest representative value; and storing 308, for each activation value of the plurality of activation values, the corresponding residual value and an index of the corresponding nearest representative value.

The method of FIG. 4 differs from FIG. 3 in that the method of FIG. 4 includes applying 402 a quantization function to the corresponding residual value for each activation value of the plurality of activation values. For example, the mapping module 114 applies a quantization function to the residual values prior to compression. The quantization function serves to constrain or map the residual values to a smaller or discrete set of values. For example, in some embodiments, the quantization function rounds an input residual value up or down. In other embodiments, the quantization function reduces a degree of precision of the input residual value (e.g., by reducing a number of bits used to encode the residual value). As quantizing the residual values serves to reduce the entropy of the residual values, a greater compression efficiency is achieved when compared to compressing the unquantized residual values. Moreover, a quantization function that reduces a degree of precision for encoding the residual values also reduces the amount of memory required to store the residual values. Notably, while the compression applied to the index values and residual values is lossless, the application of a quantization function is lossy. Accordingly, one skilled in the art would appreciate that the particular quantization function applied to the residual values is chosen in order to maintain a necessary level of accuracy for the particular machine learning application while suffering an acceptable degree of loss.

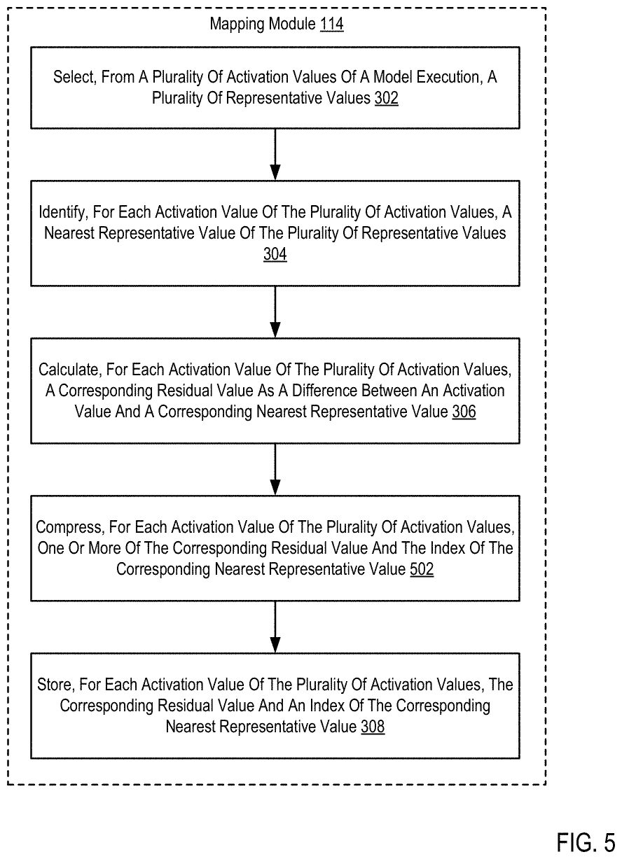

For further explanation, FIG. 5 sets forth a flow chart illustrating an exemplary method for mapping machine learning activation data to a representative value palette that includes selecting 302 (e.g., by a mapping module 114), from a plurality of activation values of a model execution, a plurality of representative values; identifying 304, for each activation value of the plurality of activation values, a nearest representative value of the plurality of representative values; calculating 306, for each activation value of the plurality of activation values, a corresponding residual value as a difference between an activation value and a corresponding nearest representative value; and storing 308, for each activation value of the plurality of activation values, the corresponding residual value and an index of the corresponding nearest representative value.

The method of FIG. 5 differs from FIG. 3 in that the method of FIG. 5 includes compressing 502, for each activation value of the plurality of activation values, one or more of the corresponding residual value and the index of the corresponding nearest representative value. For example, a statistical compression algorithm, a differential compression algorithm, or another compression algorithm is applied to the index values and residual values. Thus, less memory and less memory bandwidth is required to store the index values and residual values. As the index values have a reduced entropy when compared to the original activation values, a greater compression efficiency is achieved relative to compressing and storing the activation values. Moreover, where the entropy of the residual values is reduced by applying a quantization function, additional compression efficiency is achieved.

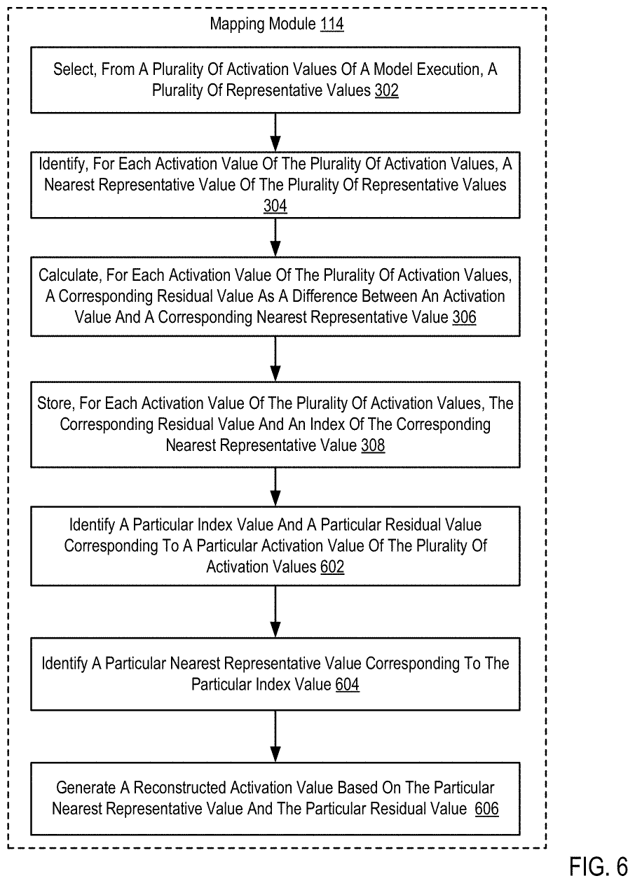

For further explanation, FIG. 6 sets forth a flow chart illustrating an exemplary method for mapping machine learning activation data to a representative value palette that includes selecting 302 (e.g., by a mapping module 114), from a plurality of activation values of a model execution, a plurality of representative values; identifying 304, for each activation value of the plurality of activation values, a nearest representative value of the plurality of representative values; calculating 306, for each activation value of the plurality of activation values, a corresponding residual value as a difference between an activation value and a corresponding nearest representative value; and storing 308, for each activation value of the plurality of activation values, the corresponding residual value and an index of the corresponding nearest representative value.

The method of FIG. 6 differs from FIG. 3 in that the method of FIG. 6 includes identifying 602 a particular index value and a particular residual value corresponding to a particular activation value of the plurality of activation values. The particular activation value is an activation value to be reconstructed from its stored corresponding index value and residual value. For example, the particular activation value is included in a plurality of activation values (e.g., an activation matrix) to be provided as input to a next layer in a machine learning model. For example, to reconstruct activation value Aⱼ, the mapping module 114 loads from memory the index value Iⱼ and the residual value In some embodiments, identifying 602 the particular index value and the particular residual value includes loading, from memory, a first block of data including a plurality of index values and a second block of data including a plurality of residual values. The particular index value and the particular residual value are then identified from the loaded data blocks.

The method of FIG. 6 also includes identifying 604 a particular nearest representative value corresponding to the particular index value. For example, assume that the mapping module 114 maintains or loads into cache the selected 302 representative values. The mapping module 114 then loads, from the representative values, the representative value at the index identified by the particular index value.

The method of FIG. 6 also includes generating 606 a reconstructed activation value based on the particular nearest representative value (e.g., identified by the loaded index value) and the particular residual value. The reconstructed activation value is generated 606 by adding the particular nearest representative value to the particular residual value. In some embodiments, the loaded residual value was quantized prior to storage. Accordingly, in such embodiments, the reconstructed activation value does not always equal the original activation value due to lossy quantization of the residual value.

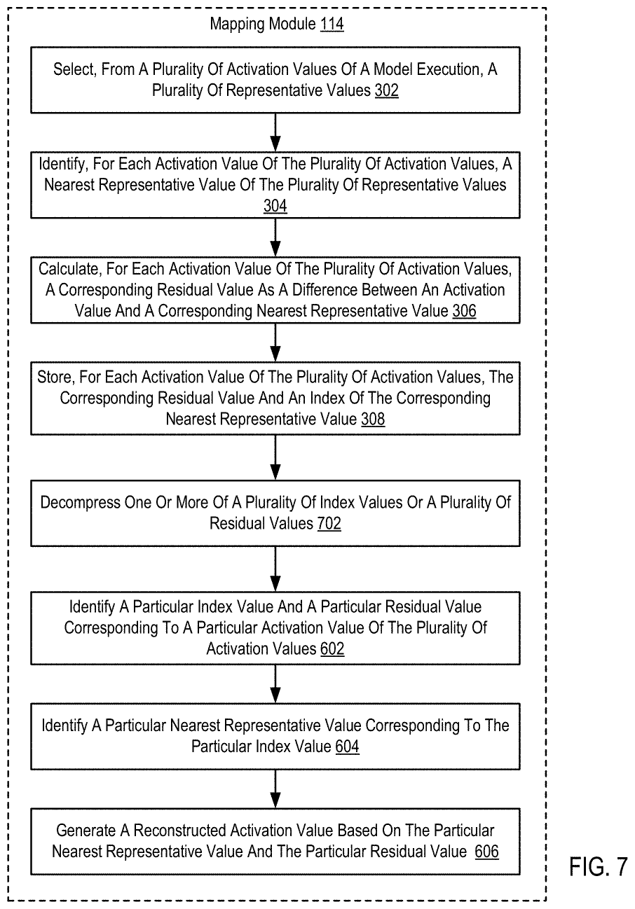

For further explanation, FIG. 7 sets forth a flow chart illustrating an exemplary method for mapping machine learning activation data to a representative value palette that includes selecting 302 (e.g., by a mapping module 114), from a plurality of activation values of a model execution, a plurality of representative values; identifying 304, for each activation value of the plurality of activation values, a nearest representative value of the plurality of representative values; calculating 306, for each activation value of the plurality of activation values, a corresponding residual value as a difference between an activation value and a corresponding nearest representative value; and storing 308, for each activation value of the plurality of activation values, the corresponding residual value and an index of the corresponding nearest representative value; identifying 602 a particular index value and a particular residual value corresponding to a particular activation value of the plurality of activation values; identifying 604 a particular nearest representative value corresponding to the particular index value; and generating 606 a reconstructed activation value based on the particular nearest representative value and the particular residual value.

The method of FIG. 7 differs from FIG. 6 in that the method of FIG. 7 includes decompressing 702 one or more of a plurality of index values or a plurality of residual values. For example, where the index values and residual values corresponding to the activation values are compressed prior to storage, the index values and residual values are decompressed prior to identifying 602 the particular index value and particular residual value of an activation value to be reconstructed. As an example, where the index values and residual values are each compressed and stored as respective data blocks, the data blocks are loaded and then decompressed 702 on a per-block basis.

In view of the explanations set forth above, readers will recognize that the benefits of mapping machine learning activation data to a representative value palette include:
Improved performance of a computing system by increasing compression efficiency, memory bandwidth, and memory storage for activation data by reducing data entropy prior to compression.
Improved performance of a computing system by reducing memory bandwidth and memory storage for activation data by storing reduced size representative value indexes and reduced precision residual values.

Exemplary embodiments of the present disclosure are described largely in the context of a fully functional computer system for mapping machine learning activation data to a representative value palette. Readers of skill in the art will recognize, however, that the present disclosure also can be embodied in a computer program product disposed upon computer readable storage media for use with any suitable data processing system. Such computer readable storage media can be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present disclosure.

The present disclosure can be a system, a method, and/or a computer program product. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which includes one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes can be made in various embodiments of the present disclosure. The descriptions in this specification are for purposes of illustration only and are not to be construed in a limiting sense. The scope of the present disclosure is limited only by the language of the following claims.

What is claimed is:

1. A method of mapping machine learning activation data to a representative value palette, the method comprising:
selecting, from a plurality of activation values of a model execution, a plurality of representative values;
identifying, for each activation value of the plurality of activation values, a representative value of the plurality of representative values;
calculating, for each activation value of the plurality of activation values, a corresponding residual value as a difference between an activation value and a corresponding representative value; and
storing, for each activation value of the plurality of activation values, the corresponding residual value and an index of the corresponding representative value.

2. The method of claim 1, further comprising applying a quantization function to the corresponding residual value for each activation value of the plurality of activation values.

3. The method of claim 1, further comprising compressing, for each activation value of the plurality of activation values, one or more of the corresponding residual value and the index of the corresponding representative value.

4. The method of claim 1, wherein the plurality of representative values comprise a selection of most frequently occurring activation values.

5. The method of claim 1, further comprising:
identifying a particular index value and a particular residual value corresponding to a particular activation value of the plurality of activation values;
identifying a particular representative value corresponding to the particular index value; and
generating a reconstructed activation value based on the particular representative value and the particular residual value.

6. The method of claim 5, further comprising decompressing one or more of a plurality of index values or a plurality of residual values.

7. The method of claim 1, wherein the index of the corresponding representative value is stored at a lesser degree of precision relative to the plurality of activation values.

8. An apparatus for mapping machine learning activation data to a representative value palette, the apparatus configured to perform steps comprising:
selecting, from a plurality of activation values of a model execution, a plurality of representative values;
identifying, for each activation value of the plurality of activation values, a representative value of the plurality of representative values;
calculating, for each activation value of the plurality of activation values, a corresponding residual value as a difference between an activation value and a corresponding representative value; and
storing, for each activation value of the plurality of activation values, the corresponding residual value and an index of the corresponding representative value.

9. The apparatus of claim 8, wherein the steps further comprise applying a quantization function to the corresponding residual value for each activation value of the plurality of activation values.

10. The apparatus of claim 8, wherein the steps further comprise compressing, for each activation value of the plurality of activation values, one or more of the corresponding residual value and the index of the corresponding representative value.

11. The apparatus of claim 8, wherein the plurality of representative values comprise a selection of most frequently occurring activation values.

12. The apparatus of claim 8, wherein the steps further comprise:
identifying a particular index value and a particular residual value corresponding to a particular activation value of the plurality of activation values;
identifying a particular representative value corresponding to the particular index value; and
generating a reconstructed activation value based on the particular representative value and the particular residual value.

13. The apparatus of claim 12, wherein the steps further comprise decompressing one or more of a plurality of index values or a plurality of residual values.

14. The apparatus of claim 8, wherein the index of the corresponding representative value is stored at a lesser degree of precision relative to the plurality of activation values.

15. A computer program product disposed upon a non-transitory computer readable medium, the computer program product comprising computer program instructions for mapping machine learning activation data to a representative value palette that, when executed, cause a computer system to perform steps comprising:
selecting, from a plurality of activation values of a model execution, a plurality of representative values;
identifying, for each activation value of the plurality of activation values, a representative value of the plurality of representative values;
calculating, for each activation value of the plurality of activation values, a corresponding residual value as a difference between an activation value and a corresponding representative value; and
storing, for each activation value of the plurality of activation values, the corresponding residual value and an index of the corresponding representative value.

16. The computer program product of claim 15, wherein the steps further comprise applying a quantization function to the corresponding residual value for each activation value of the plurality of activation values.

17. The computer program product of claim 15, wherein the steps further comprise compressing, for each activation value of the plurality of activation values, one or more of the corresponding residual value and the index of the corresponding representative value.

18. The computer program product of claim 15, wherein the plurality of representative values comprise a selection of most frequently occurring activation values.

19. The computer program product of claim 15, wherein the steps further comprise:
identifying a particular index value and a particular residual value corresponding to a particular activation value of the plurality of activation values;
identifying a particular representative value corresponding to the particular index value; and
generating a reconstructed activation value based on the particular representative value and the particular residual value.

20. The computer program product of claim 19, wherein the steps further comprise decompressing one or more of a plurality of index values or a plurality of residual values.
